(19) United States
(12) Patent Application Publication
(10) Pub. No.: US 2020/0132214 A1
(43) Pub. Date: Apr. 30, 2020

(54) Solenoid Valve and Method for Operating a Solenoid Valve

(71) Applicant: Andreas Stihl AG & Co. KG, Waiblingen (DE)

(72) Inventors: Klaus Geyer, Sulzbach (DE); Jens Ramler, Backnang (DE)

(21) Appl. No.: 16/662,079

(22) Filed: Oct. 24, 2019

(30) Foreign Application Priority Data
Oct. 25, 2018 (DE) 10 2018 008 410.9

(51) Int. Cl. F16K 31/56; F16K 31/06

(52) U.S. Cl. CPC F16K 31/566; F16K 31/0651

(57) ABSTRACT

A solenoid valve has a valve housing, a magnetic core, and an armature plate interacting with the magnetic core and actuating a valve body. The solenoid valve has first and second travel positions defined by first and second distances measured between armature plate and magnetic core, respectively. The first distance is longer than the second distance. Flow through the solenoid valve is possible in one of the first and second travel positions and blocked in the other. The armature plate has a travel from first to second travel position and has an intermediate position located between first and second travel positions. A first spring element acts on the armature plate across the entire travel from first to second travel position. A second spring element acts additionally on the armature plate and begins acting from the intermediate position of the armature plate onward toward the second travel position.

### BACKGROUND OF THE INVENTION

The invention relates to a solenoid valve with a valve housing, a magnetic core, and a metallic armature plate interacting with the magnetic core. The armature plate actuates a valve body. The solenoid valve comprises a first travel position with a first distance between the armature plate and the magnetic core and further comprises a second travel position with a second distance between the armature plate and the magnetic core. The first distance in the first travel position is longer than the second distance in the second travel position. Flow through the solenoid valve is open in one of the two travel positions and blocked in the other travel position. The armature plate comprises a travel from the first travel position to the second travel position. The solenoid valve comprises a first spring element and a second spring element, wherein the first spring element is acting on the armature plate across the entire travel.

The invention further relates to a method for operating such a solenoid valve.

DE 100 16 599 A1discloses a solenoid valve. The solenoid valve comprises a magnetic core, an armature as well as two spring elements. The armature is tensioned by means of the spring elements against the magnetic core. By energizing the coil extending about the magnetic core, the armature is attracted by the magnetic core so that the valve opens. When the coil is not energized, the magnetic core is pushed back by the spring elements into its initial position so that the solenoid valve is closed. Both spring elements act simultaneously across the entire travel of the armature from the open into the closed position of the solenoid valve parallel to the armature. The spring elements have a progressive characteristic curve.

The spring force of the two spring elements is configured such that it is approximately in balance with the magnetic force of the armature in order to enable a proportional control of the valve travel. Since the spring force approximately corresponds to the magnetic force, the response times of such valves are comparatively higher. A fast opening or closing of the solenoid valve is not possible.

It is an object of the invention to provide a solenoid valve of the aforementioned kind that enables minimal response times.

### SUMMARY OF THE INVENTION

This object is solved by a solenoid valve in which, beginning at an intermediate position of the armature plate which is located between the first travel position and the second travel position, the second spring element is acting on the armature plate all the way to the second travel position in addition to the first spring element.

Furthermore, an object of the invention resides in providing a method for operating a solenoid valve which enables reduced response times of the solenoid valve.

This object is solved by a method for operating a solenoid valve according to the invention in that, upon energizing the solenoid valve, the armature plate is moved from the first travel position into the second travel position, wherein, from the first travel position to the intermediate position, only the first spring element is acting on the armature plate, and wherein, from the intermediate position onward all the way to the second travel position, the first spring element and in addition the second spring element are acting on the armature plate.

The solenoid valve with a valve housing comprises at least a first spring element and at least a second spring element. Only the first spring element acts on the armature plate across the entire travel. The second spring element acts only from an intermediate position of the armature plate onward, wherein the intermediate position is located between the first travel position and the second travel position. The second spring element acts, beginning at the intermediate position, all the way to the second travel position in addition to the first spring element on the armature plate. The second spring element is thus acting from the intermediate position to the second travel position in addition to the first spring element. In other words, the second spring element is activated for reinforcing the first spring element only across a travel that is smaller than the total travel.

The solenoid valve according to the invention reduces advantageously the response times. Beginning at the first travel position and continuing toward the second travel position, the magnetic force acting on the armature plate has a progressively increasing characteristic curve. When the armature plate is in the first travel position and is to be moved into the second travel position by energizing the solenoid valve, the spring force is to be selected to be comparatively minimal. The magnetic force, which is low anyway in the first travel position, accelerates the armature plate with valve body and moves it as quickly as possible in the direction toward the second travel position.

When the armature plate is in the second travel position and is to be moved into the first travel position in the de-energized state of the solenoid valve, a spring force as large as possible is to be selected in order to enable a fast return into the initial position of the armature plate. In addition, great spring forces in the second travel position favor overcoming magnetic or adhesive forces which may cause the armature plate to stick to the magnetic core.

Based on the above realizations, a solenoid valve was developed that comprises a second spring element which, as a function of the travel of the armature plate, acts in addition to the first spring element. Thus, in the first travel position, only the first spring element is acting on the armature plate so that a comparatively minimal spring force is adjusted. Accordingly, the magnetic force which is comparatively minimal in the first travel position is still significantly greater than the acting spring force so that the spring force can be overcome easily and a fast movement of the armature plate in the direction of the second travel position can be enabled.

Only after performing a travel into the intermediate position, the action of the second spring element is added to that of the first spring element. In this intermediate position, the spacing between the armature plate and the magnetic core is so minimal that the magnetic force is sufficiently large in order to enable, even against the spring force of the second spring element, a fast movement of the armature plate in the direction toward the second travel position. In the second travel position, the two spring elements are preferably maximally pretensioned. In the second travel position, the two spring elements exert advantageously a comparatively high spring force on the armature plate in the direction toward the first travel position. When the solenoid valve is switched to the de-energized state, the comparatively high spring force effects a fast return into the first travel position.

When, for example, in the second travel position the armature plate is contacting the magnetic core and/or the coil, a magnetic or adhesive bond may exist. Due to the high spring forces in the second travel position, the armature plate can be released even against the magnetic or adhesive forces from the magnetic core and/or from the coil. Accordingly, with the solenoid valve according to the invention, the conflicting requirements of an initially minimal spring force in the first travel position and a particularly high spring force in the second travel position can be fulfilled by a travel-dependent actuation of two spring elements and the response times can be reduced thereby.

Advantageously, the first spring element and the second spring element are connected in parallel. Advantageously, a parallel connection of the spring elements is embodied in the solenoid valve. Advantageously, a travel-dependent parallel connection of the at least two spring elements is embodied in the solenoid valve.

The solenoid valve is preferably actuatable mono-stably into the first travel position or into the second travel position. In this way, complex control mechanisms can be avoided in particular compared to proportional valves. In addition, faster response times can be achieved.

In the first travel position, an engagement distance between the valve body and the second spring element corresponds preferably to between 20% to 80%, preferably 30% to 60%, in particular 40%, of the total travel. In other words, the engagement distance is the distance between the valve body and the second spring element in relation to the total travel when the second spring element begins to act in addition to the first spring element. Thus, the second spring element does not act at the beginning of the travel so that in the initial region of the travel only a minimal total spring force is acting. In the region of the travel near the second travel position, the second spring element is actuated so that, beginning at the intermediate position all the way to the second travel position, the second spring element is sufficiently pretensioned and a correspondingly high total spring force is acting on the armature plate.

Advantageously, the first spring element is pretensioned in the first travel position. In particular in the de-energized state of the solenoid valve, a defined position of the armature plate can be ensured in this way. For example, in case of a valve closed when de-energized, the armature plate is forced by the pretensioned spring against the valve seat in the first travel position so that a defined closed position of the solenoid valve can be realized.

The first spring element effects preferably a greater spring force on the armature plate in the second travel position than in the first travel position. The second spring element effects preferably a greater spring force on the armature plate in the second travel position than in the intermediate position. The spring force of the first spring element as well as the spring force of the second spring element increase in the direction of the second travel position so that also the total spring force acting on the armature plate increases in the direction of the second travel position. The second spring element is preferably unstressed in the first travel position of the armature plate so that the spring element exerts no force that is acting on the armature plate.

The first spring element comprises a first spring constant and the second spring element comprises a second spring constant. The second spring constant is preferably higher than the first spring constant. In this way, an approximately progressive characteristic curve of the total spring force can be generated that leads to a fast return of the armature plate from the second travel position into the first travel position.

The first spring constant of the first spring element is preferably linear. The second spring constant of the second spring element is advantageously linear. Due to the linear spring constants, the spring force acting on the armature plate increases also linearly per spring element for a corresponding spring travel of the spring element.

The second spring element contacts preferably the valve body in the intermediate position of the armature plate. Accordingly, the spring force which is exerted by the second spring element is transmitted through the valve body onto the armature plate.

In the energized state of the solenoid valve, it is advantageously provided that, in each position of the armature plate relative to the magnetic core, a total spring force of the first spring element and of the second spring element acting on the armature plate is smaller than a magnetic force of the solenoid valve acting on the armature plate. In this way, it is ensured that in each travel position of the armature plate with energized solenoid valve the total spring force can be overcome by the magnetic force and a movement of the armature plate in the direction of the second travel position is carried out. In the energized state of the solenoid valve, the total spring force is preferably at most 90%, advantageously 65%, of the magnetic force in each position of the armature plate relative to the magnetic core. In this way, a fast actuation of the solenoid valve into the second travel position is enabled from any travel position.

### BRIEF DESCRIPTION OF THE DRAWING

FIG. 1 is a partial schematic section illustration of a solenoid valve that is closed when de-energized, showing the closed position.

FIG. 2 is a partial schematic section illustration of the solenoid valve of FIG. 1 in the open position.

FIG. 3 is a partial schematic section illustration of a solenoid valve that is open when de-energized, showing the open position.

FIG. 4 is a partial schematic section illustration of the solenoid valve of FIG. 3 in the closed position.

FIG. 5 is a diagram of a schematic spring characteristic curve of the solenoid valve according to the invention.

FIG. 6 is a section illustration of a solenoid valve that is closed when de-energized, showing the closed position.

FIG. 7 is a schematic section illustration of the solenoid valve according to FIG. 6 in an intermediate position.

FIG. 8 is a section illustration of the solenoid valve according to FIG. 6 in the closed position.

### DESCRIPTION OF PREFERRED EMBODIMENTS

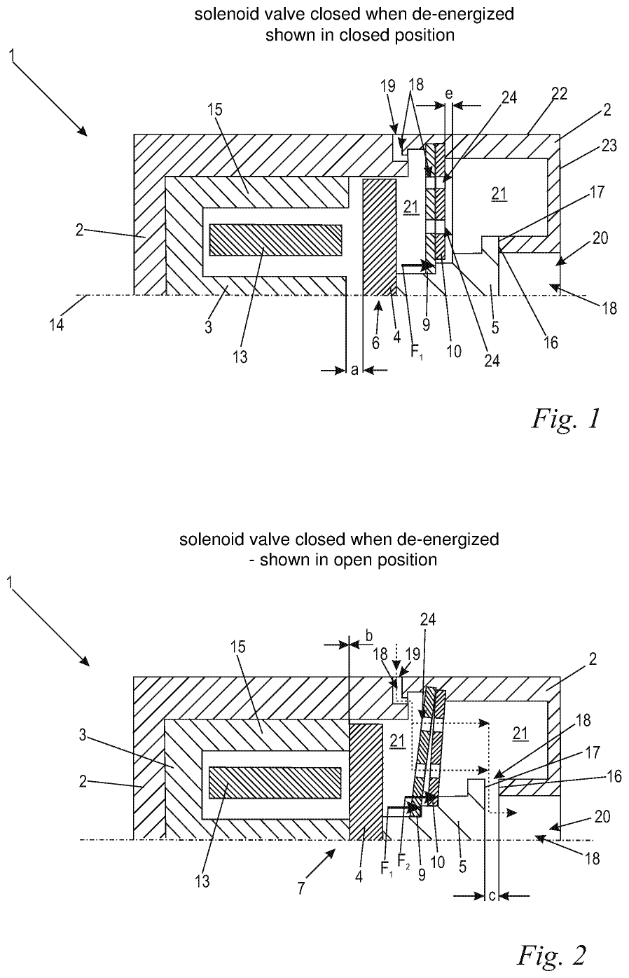

An embodiment of a solenoid valve in accordance with the invention is illustrated in FIGS. 1 and 2, which is embodied as a solenoid valve 1 that is closed when de-energized. To avoid overcrowding, only one half of the solenoid valve 1 is illustrated; this half ends at a plane that extends in the viewing direction of FIGS. 1 and 2, wherein the plane contains a longitudinal axis 14 of the solenoid valve 1.

As illustrated in FIGS. 1 and 2, the solenoid valve 1 comprises an electric drive coil 13 in which a magnetic core 3 is arranged. The magnetic core 3 is preferably formed as one piece together with a yoke 15 surrounding the electric drive coil 13. The yoke 15 is advantageously embodied cup-shaped. Moreover, the solenoid valve 1 comprises a metallic armature plate 4 and a valve body 5 which is preferably fixedly connected to the armature plate 4. The magnetic core 3 with the yoke 15, the drive coil 13, and the armature plate 4 with the valve body 5 are preferably arranged coaxial to the longitudinal axis 14 of the solenoid valve 1 and are surrounded by a valve housing 2. The magnetic core 3, the yoke 15 as well as the drive coil 13 are preferably fixedly connected to the valve housing 2. The armature plate 4 with the valve body 5 is movable in the direction of the longitudinal axis 14 of the solenoid valve 1 relative to the valve housing 2. The solenoid valve 1 is connected by means of a connecting plug, not illustrated, to an electric circuit and can be supplied with current. When supplying current to the electric drive coil 13, a magnetic field is generated in interaction with the magnetic core 3 and the yoke 15; the magnetic field produces a magnetic force F_{M} acting on the armature plate 4 in the direction from the armature plate 4 to the magnetic core 3. Due to the magnetic force F_{M}, the armature plate 4 is attracted in the direction toward the magnetic core 3. When the drive coil 13 is currentless, essentially no magnetic force F_{M} is acting on the armature plate 4.

The solenoid valve 1 is mono-stable in a first travel position 6 (FIG. 1) and can be moved into a second travel position 7 (FIG. 2). In the first travel position 6, the armature plate 4 and the magnetic core 3 define a first distance a measured in the direction of the longitudinal axis 14. In the second travel position 7, the armature plate 4 and the magnetic core 3 define a second distance b measured in the direction of the longitudinal axis 14. The first distance a in the first travel position 6 is longer than the second distance b in the second travel position 7. The distance which is covered by the armature plate 4 from the first travel position 6 into the second travel position 7 corresponds to a travel c.

As indicated in FIGS. 1 and 2, the solenoid valve 1 comprises a circumferential side 22 which is arranged approximately concentrically relative to the longitudinal axis 14, and two end faces 23 perpendicular to the longitudinal axis 14. Moreover, the solenoid valve 1 comprises a closable flow channel 18 extending through the solenoid valve 1 for flow of a medium therethrough, in the embodiment a fluid.

In the embodiment, the flow channel 18 is comprised of an inlet channel 19 and an outlet channel 20. The inlet channel 19 extends from the circumferential side 22 into a valve interior 21. The outlet channel 20 extends from the valve interior 21 to the end face 23. The valve interior 21 is substantially limited by the valve housing 2. It can be expedient to provide several flow channels 18 in the solenoid valve 1 in order to adjust the flow quantity, for example, the flow quantity of the fuel supply, as needed.

Moreover, the solenoid valve 1 comprises a valve seat 16. The valve seat 16 is advantageously embodied at the valve housing 2 and the solenoid valve 1 comprises advantageously a sealing surface 17 which is formed at the valve body 5. The valve seat 16 of the valve housing 2 is interacting with the sealing surface 17 of the valve body 5. In the embodiment according to FIG. 1, in the first travel position 6, the valve seat 16 and the sealing surface 17 of the valve body 5 are in contact and the flow channel 18 is closed. The flow communication between the valve interior 21 and the outlet channel 20 is interrupted. However, when the sealing surface 17, as illustrated in FIG. 2, is not contacting the valve seat 16, the flow channel 18 is open. The solenoid valve 1 is in the second travel position 7. The inlet channel 19 is in flow communication with the outlet channel 20 so that the fluid can flow through the solenoid valve 1. In the embodiment according to FIGS. 1 and 2, the flow through the flow channel 18 is blocked in the first travel position 6 and is open in the second travel position 7.

As illustrated in FIGS. 1 and 2, the solenoid valve 1 comprises a first spring element 9 and a second spring element 10. Advantageously, the first spring element 9 and the second spring element 10 are arranged concentric to the longitudinal axis 14 in the valve interior 21. The spring elements 9, 10 are embodied in the illustrated embodiment as flat springs. However, also other spring types may be expedient, for example, spiral springs, plate springs or molded springs. Moreover, the spring elements 9, 10 advantageously have openings 24. The openings 24 enable flow of the fluid through the spring elements 9, 10. In this way, upon closing and opening of the solenoid valve 1, a displacement of the fluid in the valve interior 21 is enabled and a flow communication between the inlet channel 19 and the outlet channel 20 is produced.

In the embodiment, the spring elements 9, 10 each have an outer circumference and an inner circumference. The spring elements 9, 10 are fastened by means of their outer circumference at the valve housing 2. The first spring element 9 is moreover secured with its inner circumference at the valve body 5. The first spring element 9 acts via the valve body 5 on the armature plate 4 across the entire travel c in the direction from the magnetic core 3 to the armature plate 4. The first spring element 9 exerts a first spring force F₁ which acts in the direction from the magnetic core 3 to the armature plate 4. Also, the first spring force F₁ is acting opposite to the magnetic force F_{M}. When the solenoid valve 1 is de-energized, the first spring element 9 pushes the valve body 5 with its sealing surface 17 against the valve seat 16 and closes off the flow channel 18. In order to ensure a sufficiently high closure force between the sealing surface 17 and the valve seat 16, the first spring element 9 in the embodiment is already pretensioned in the first travel position 6. With increasing travel of the armature plate 4, the spring travel of the first spring element 9 increases also so that the first spring force F₁ is increased. Accordingly, the first spring force F₁ which is exerted by the first spring element 9 is maximal in the second travel position 7 and is minimal in the first travel position 6.

As illustrated in FIG. 1, the second spring element 10 comprises an engagement distance e, measured in the longitudinal direction 14, relative to the valve body 5 in the direction of the first travel position 6. Beginning at the first travel position 6, the valve body 5 must overcome the engagement distance e before the valve body 5 can contact the second spring element 10 in the region of the inner circumference in an intermediate position 8. In the intermediate position 8, the armature plate 4 and the valve body 5 are located between the first travel position 6 and the second travel position 7. In the embodiment, in the first travel position 6 the engagement distance e between the valve body 5 and the second spring element 10 corresponds to between 20% to 80%, preferably 30% to 60%, in particular 40%, of the entire travel c. Beginning at the first travel position 6, the second spring element 10 is acting through the valve body 5 on the armature plate 4 only from the intermediate position 8 of the armature plate 4 onward. Accordingly, the second spring element 10 is acting on the armature plate 4 only when the armature plate 4 is located in a region between the intermediate position 8 and the second travel position 7. The second spring element 10 acts on the armature plate 4 in the direction from the magnetic core 3 toward the armature plate 4. The second spring element 10 exerts a second spring force F₂ which is acting in the direction from the magnetic core 3 toward the armature plate 4. In addition, the second spring force F₂ acts opposite to the magnetic force F_{M}. With increase of the travel length of the armature plate 4, beginning at the intermediate position 8 in the direction toward the second travel position 7, also the spring travel of the second spring element 10 increases so that the second spring force F₂ increases. Accordingly, the second spring force F₂ applied by the second spring element 10 on the armature plate 4 is maximal in the second travel position 7 and minimal in the intermediate position 8.

The first spring element 9 and the second spring element 10 act from the intermediate position 8 to the second travel position 7 in parallel on the armature plate 4. The first spring element 9 and the second spring element 10 are connected in parallel so that a total spring force F_{G} results which is the sum of the first spring force F₁ and of the second spring force F₂.

The solenoid valve 1 according to FIGS. 1 and 2 controls the flow of the fluid in accordance with the following principle.

When the current is switched off in the electrical drive coil 13, the solenoid valve 1 is in the first travel position 6 (FIG. 1). The first spring element 9 pushes with a first spring force F₁ the valve body 5 with its sealing surface 17 against the valve seat 16 at the valve housing 2. The flow of fluid from the valve interior 21 to the outlet channel 20 is blocked. Accordingly, there is no flow communication between the inlet channel 19 and the outlet channel 20 so that the flow channel 18 is blocked. The armature plate 4 which is preferably fixedly connected to the valve body 5 has in this position a maximum distance a relative to the magnetic core 3. The second spring element 10 has relative to the valve body 5 an engagement distance e and therefore does not act on the armature plate 4. The total spring force F_{G} which is acting on the valve body 5 corresponds to the minimal first spring force F₁ which is exerted by the first spring element 9.

With switched-on current in the electrical drive coil 13, a magnetic force F_{M} is generated which is acting on the armature plate 4 in the direction from the armature plate 4 toward the magnetic core 3. The magnetic force F_{M} acting on the armature plate 4 is greater than the total spring force F_{G} so that the armature plate 4 with valve body 5 is pulled opposite to the total spring force F_{G} in the direction toward the magnetic core 3. The valve seat 16 is released and the flow channel 18 is opened. While the armature plate 4 is pulled from the first travel position 6 into the intermediate position 8, only the first spring element 9 is acting against magnetic force F_{M}. The magnetic force F_{M} is therefore significantly greater than the total spring force F_{G} so that the armature plate 4 can be quickly moved in the direction toward the magnetic core 3. When the armature plate 4 has reached the intermediate position 8, the engagement distance e has been overcome and the valve body 5 and the second spring element 10 contact each other. Beginning at the intermediate position 8, the first spring element 9 and the second spring element 10 act opposite to the magnetic force F_{M}. Since in the energized state of the solenoid valve 1 in each position of the armature plate 4 relative to the magnetic core 3 the total spring force F_{G} acting on the armature plate 4 is smaller than the magnetic force F_{M} acting on the armature plate 4, the armature plate 4 is pulled farther toward the magnetic core 3 into the second travel position 7. In order to enable a fast movement of the armature plate 4 in the direction toward the magnetic core 3, in each position of the armature plate 4 relative to the magnetic core 3 the total spring force F_{G} is at most 90%, in particular 65% of the magnetic force F_{M} in the energized state of the solenoid valve 1.

In the second travel position 7 (FIG. 2) the armature plate 4 is contacting the valve housing 2 and/or the magnetic core 3. In this context, the armature plate 4 has a minimal distance b to the magnetic core 3 which is smaller than the distance a in the first travel position 6. The solenoid valve 1 in the embodiment according to FIGS. 1 and 2 is completely open. The fluid flows from the inlet channel 19 into the valve interior 21, through the openings 24 of the spring elements 9, 10 past the valve body 5 into the outlet channel 20. The flow channel 18 is open.

When in the second travel position 7 of the solenoid valve 1 the current supply is switched off, the magnetic force F_{M} is switched off also. The total spring force F_{G} acts on the armature plate 4 in the direction toward the first travel position 6. Since as a result of the parallel connection of the spring elements 9, 10 the total spring force F_{G} in the second travel position 7 is comparatively large, the armature plate 4 is moved at a high acceleration in the direction toward the first travel position 6. The high total spring force F_{G} overcomes magnetic or adhesive bonding forces which may occur between the armature plate 4 and the magnetic core 3 or the valve housing 2. A fast and reliable closure of the solenoid valve 1 is enabled.

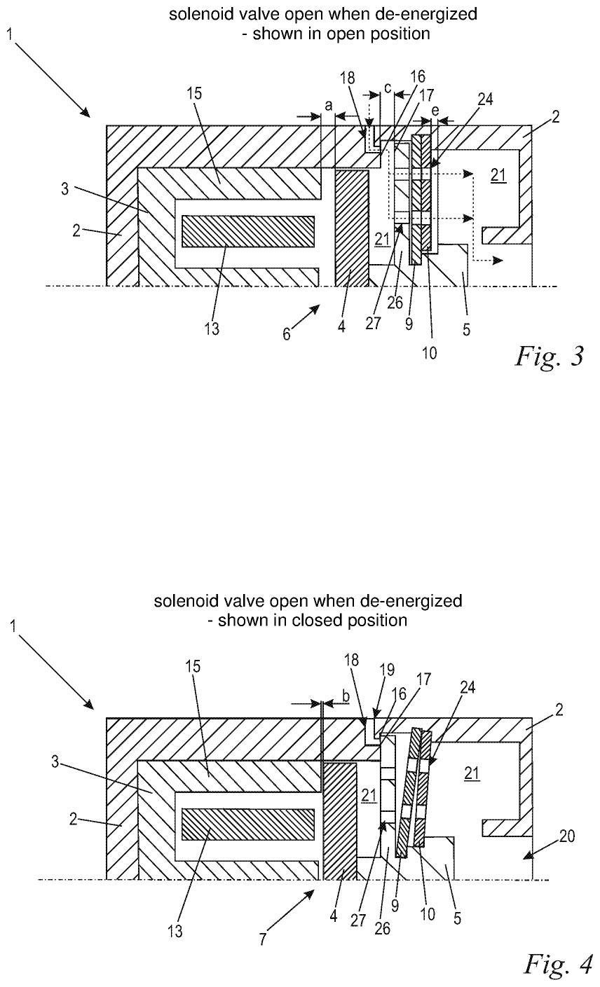

In FIGS. 3 and 4 an embodiment according to the invention of a solenoid valve 1 is illustrated which is embodied as a solenoid valve that is open when de-energized. The embodiment differs from the embodiment according to FIGS. 1 and 2 in that the solenoid valve 1 in the first travel position 6 (FIG. 3) is open and in the second travel position 7 (FIG. 4) is closed. In the embodiment, the valve seat 16 is embodied for this purpose at the valve housing 2 at the inlet channel 19 toward the valve interior 21. The sealing surface 17 which is interacting with the valve seat 16 is embodied at the valve body 5 in the embodiment. Preferably, the valve seat 16 is embodied at a side of the valve housing 2 which is facing away from the magnetic core 3 and the sealing surface 17 is provided at a side of the valve body 5 which is facing the magnetic core 3. Such a sealing surface 17, as in the embodiment, can be formed at a shoulder 27 of the valve body 5 or, in an alternative embodiment according to the invention, at the armature plate 4. For flow communication between inlet channel 19 and outlet channel 20, openings 27 are required at the shoulder 26 of the valve body 5 or at the armature plate 4. For closing the solenoid valve 1, the drive coil 13 is energized so that the armature plate 4 is pulled against the magnetic core 3 by means of the magnetic force F_{M}. The sealing surface 17 of the valve body 5 is pressed against the valve seat 16 at the valve housing 2. In doing so, the inlet channel 19 is closed off relative to the valve interior 21. The flow channel 18 is blocked.

Actuation and action of the spring elements 9, 10 with regard to the first travel position 6, the intermediate position 8, and the second travel position 7 of the solenoid valve 1 are identical to the embodiment of FIGS. 1 and 2.

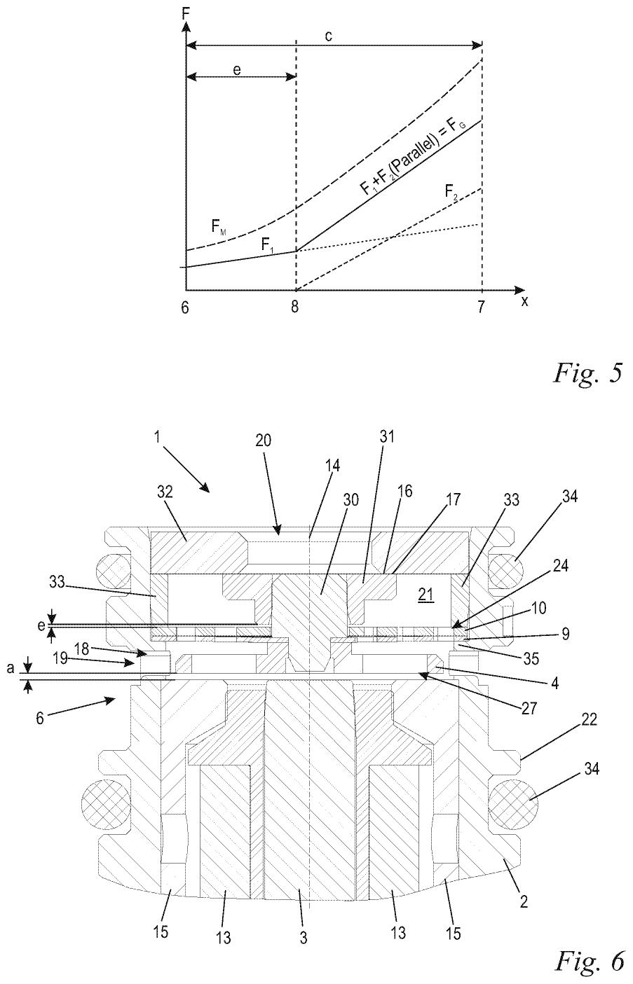

In FIG. 5, a diagram is illustrated that shows the spring characteristic curve of a solenoid valve 1 according to the invention. On the vertical axis, the spring force F is shown and on the horizontal axis the spring travel x is illustrated. The spring force of the first spring element 9 is identified by F₁. The spring force of the second spring element 10 is identified by F₂. The spring travel of the spring elements 9, 10 corresponds to the travel of the armature plate 4 and of the valve body 5. The spring travel of the first spring element 9 begins in the first travel position 6, wherein the first spring element 9 is pretensioned in the embodiment. In this way, a minimum spring force is acting on the valve body 5 which secures it in a defined stop position, the first travel position 6.

The first spring element 9 comprises across the entire travel c a linear first spring constant 11. After the valve body 5 has traveled the engagement distance e between the first travel position 6 and the intermediate position 7, the valve body 5 contacts the second spring element 10. As can be seen in the diagram of FIG. 5, the second spring element 10 is not pretensioned. Therefore, the spring force F₂ of the second spring element 10 in the intermediate position 8 is zero. The second spring element 10 comprises a linear second spring constant 12. With increasing travel beginning at the intermediate position 8 in the direction of the second travel position 7, the second spring force F₂ of the second spring element 10 increases in addition to the first spring force F₁ of the first spring element 9. The second spring constant 12 of the second spring element 10 in the illustrated diagram is greater than the first spring constant 11 of the first spring element 9. As illustrated in the diagram, the spring elements 9, 10 are parallel connected between the intermediate position 8 and the second travel position 7. In this way, the first spring force F₁ and the second spring force F₂ add up to the total spring force F_{G} which is acting on the valve body 5 and which is greater than the individual spring forces F₁, F₂. In an alternative embodiment also in accordance with the invention of the solenoid valve 1, the spring constants 11, 12 of the spring elements 9, 10 can also have a progressive characteristic curve.

In FIGS. 6, 7, and 8, a further embodiment of the solenoid valve 1 according to the invention in different travel positions is illustrated which is embodied as a valve that is closed in the de-energized state. The embodiment corresponds substantially to the solenoid valve illustrated in FIGS. 1 and 2.

The valve body 5 is of a two-part configuration and comprises a pin element 30 and a ring element 31 pushed onto the pin element 30. The sealing surface 17 is provided at the ring element 31. The valve seat 16 is formed at a bottom plate 32 which is mounted in the valve housing 2. The bottom plate 32 has an opening which is advantageously concentric to the longitudinal axis 14 and forms the outlet channel 20. At the side of the bottom plate 32 which is facing the magnetic core 3, the valve seat 16 is embodied to extend circumferentially about the opening of the bottom plate 32.

The spring elements 9, 10 are secured at their outer ends by means of a clamping ring 33 against a shoulder 35 of the valve housing 2. The clamping ring 33 is pushed by means of the bottom plate 32 against the valve housing 2. In the embodiment, the outer ends of the spring elements 9, 10 are positioned atop each other but it can also be expedient to fasten the spring elements 9, 10 spaced apart from each other at the valve housing 2. The first spring element 9 is secured by clamping at its inner circumference between the pin element 30 and the armature plate 4. Accordingly, the first spring element 9 is acting on the armature plate 4 in each travel position. The second spring element 10, on the other hand, is arranged at its inner circumference in longitudinal direction 14 between the first spring element 9 and the valve body 5, i.e., the ring element 31 in this embodiment. In this context, the second spring element 10 is positioned relative to the valve body 5 at an engagement distance e measured in the longitudinal direction 14. Moreover, the solenoid valve 1 comprises two sealing elements 34 that are arranged at the circumferential side 22 of the valve housing 2 and are formed in the embodiment as 0-rings.

In FIG. 6, the solenoid valve 1 is shown in the first travel position 6 in which the flow channel 18 is closed and flow of fluid is blocked.

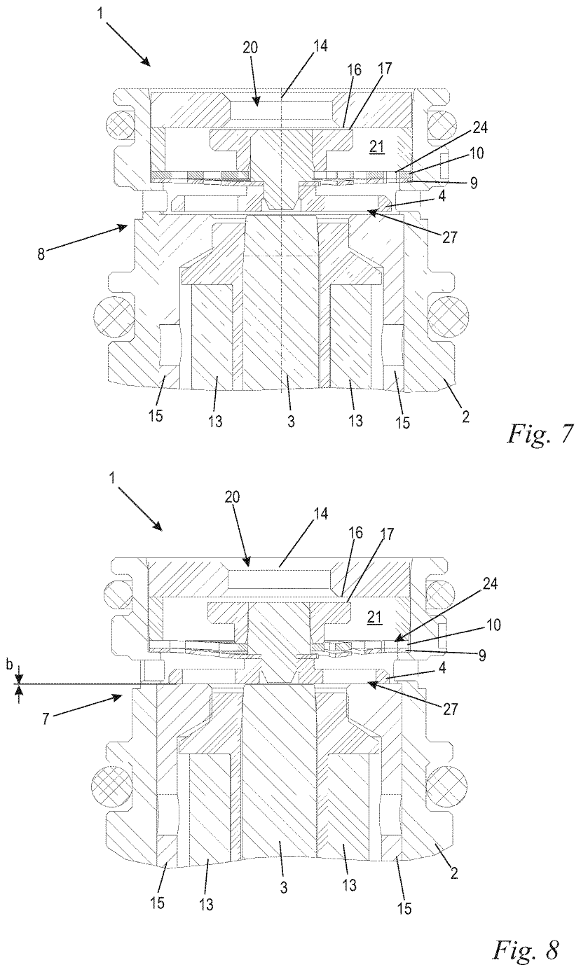

In FIG. 7, the solenoid valve 1 is illustrated in the intermediate position 8 in which the valve is already open and the valve body 5 has overcome the engagement distance e. The valve body 5 contacts the second spring element 10 which, beginning at the intermediate position 8, additionally is acting on the armature plate 4, advantageously parallel to the first spring element 9. In FIG. 8, the solenoid valve 1 is illustrated in the second travel position 7 in which the flow channel 18 is completely open. The functional principles according to the invention of the embodiment according to FIGS. 1 and 2 are to be applied to the embodiment of FIGS. 6, 7, and 8.

Further advantageous embodiments result from any combination of the features of the aforementioned embodiments.

The specification incorporates by reference the entire disclosure of German priority document 10 2018 008 410.9 having a filing date of Oct. 25, 2018.

While specific embodiments of the invention have been shown and described in detail to illustrate the inventive principles, it will be understood that the invention may be embodied otherwise without departing from such principles.

What is claimed is:

1. A solenoid valve comprising:
a valve housing:
a magnetic core;
a metallic armature plate interacting with the magnetic core;
a valve body actuated by the armature plate;
wherein the solenoid valve comprises a first travel position defined by a first distance measured between the armature plate and the magnetic core and further comprises a second travel position defined by a second distance measured between the armature plate and the magnetic core, wherein the first distance is longer than the second distance;
wherein a flow communication through the solenoid valve in one of the first and second travel positions is open and in the other one of the first and second travel positions is blocked;
wherein the armature plate comprises a travel from the first travel position to the second travel position and wherein the armature plate comprises an intermediate position located between the first travel position and the second travel position;
a first spring element acting on the armature plate across the entire travel of the armature plate from the first travel position into the second travel position;
a second spring element acting on the armature plate in addition to the first spring element, wherein the second spring element begins to act on the armature plate from the intermediate position of the armature plate onward toward the second travel position.

2. The solenoid valve according to claim 1, configured to be actuated mono-stably into the first travel position or into the second travel position.

3. The solenoid valve according to claim 1, wherein in the first travel position an engagement distance between the valve body and the second spring element amounts to between 20% to 80% of the entire travel.

4. The solenoid valve according to claim 3, wherein the engagement distance between the valve body and the second spring element amounts to between 30% to 60% of the entire travel.

5. The solenoid valve according to claim 4, wherein the engagement distance between the valve body and the second spring element amounts to 40% of the entire travel.

6. The solenoid valve according to claim 1, wherein the first spring element is pretensioned in the first travel position.

7. The solenoid valve according to claim 1, wherein a spring force of the first spring element acting on the armature plate is greater in the second travel position than in the first travel position.

8. The solenoid valve according to claim 1, wherein a spring force of the second spring element acting on the armature plate is greater in the second travel position than in the intermediate position.

9. The solenoid valve according to claim 1, wherein the first spring element comprises a first spring constant and the second spring element comprises a second spring constant, wherein the second spring constant is greater than the first spring constant.

10. The solenoid valve according to claim 9, wherein the first spring constant is linear.

11. The solenoid valve according to claim 9, wherein the second spring constant is linear.

12. The solenoid valve according to claim 1, wherein the second spring element contacts the valve body in the intermediate position of the armature plate.

13. The solenoid valve according to claim 1, wherein in an energized state of the solenoid valve, in each position of the armature plate relative to the magnetic core, a total spring force of the first spring element and of the second spring element is less than a magnetic force of the solenoid valve acting on the armature plate.

14. The solenoid valve according to claim 13, wherein in the energized state of the solenoid valve, in each position of the armature plate relative to the magnetic core, the total spring force is at most 90% of the magnetic force.

15. The solenoid valve according to claim 14, wherein in the energized state of the solenoid valve, in each position of the armature plate relative to the magnetic core, the total spring force is 65% of the magnetic force.

16. A method for operating a solenoid valve according to claim 1, the method comprising:
moving, upon energizing the solenoid valve, the armature plate from the first travel position into the second travel position;
acting only with the first spring element on the armature plate from the first travel position to the intermediate position of the armature plate;
acting with the first spring element and additionally with the second spring element on the armature plate from the intermediate position to the second travel position.
